(19) United States
(12) Patent Application Publication
(10) Pub. No.: US 2026/0266247 A1
(43) Pub. Date: Sep. 10, 2026

(54) FUEL SUPPLY MODULE

(71) Applicant: WALBRO LLC, Cass City, MI (US)

(72) Inventors: Paul V. VERHINES, Cass City, MI (US); Steven SCHOOLEY, Bay Port, MI (US); Elton FISCH, Caro, MI (US)

(73) Assignee: WALBRO LLC, Cass City, MI (US)

(21) Appl. No.: 19/560,668

(22) Filed: Mar. 9, 2026

Related U.S. Application Data
(60) Provisional application No. 63/768,520, filed on Mar. 7, 2025.

(51) Int. Cl. F02M 25/08; F02M 37/00; F02M 37/18

(52) U.S. Cl. CPC F02M 25/089; F02M 25/0872; F02M 37/0047; F02M 37/18

(57) ABSTRACT

A fuel supply module for delivering liquid fuel to a fuel rail includes a housing containing a fuel reservoir and a vapor reservoir formed by a seal between the housing and an inlet adapter. The inlet adapter couples to a main pump. The inlet adapter includes an upper cup having ports and an opposing lower cup having passage from the fuel reservoir to the lower cup interior for supplying fuel to the main pump. A hollow central column extends from the upper cup and defines a vapor opening placing the vapor reservoir and upper cup interior in communication with the lower cup interior. Ullage flows through the ports into the vapor reservoir and passes through the vapor opening to combine with fuel for consumption by the engine to prevent vapor lock.

### CROSS-REFERENCE TO RELATED APPLICATIONS

This application claims the benefit of priority of U.S. Provisional Application No. 63/768,520, filed on Mar. 7, 2025, the disclosure of which is incorporated herein by reference in its entirety.

### FIELD OF THE INVENTION

The subject disclosure relates generally to fuel supply modules, and more particularly to fuel supply modules for marine motors. Specifically, the present disclosure relates to a fuel supply module for use with marine engines and fuel systems having multiple pumps and an adapter for vapor regulation.

### BACKGROUND

Fuel supply modules (FSMs) are commonly incorporated into marine propulsion systems to deliver fuel from a supply or storage tank to an associated marine engine. In many arrangements, a FSM includes one or more fuel pumps configured to transfer liquid fuel to the engine at a desired pressure and flow rate. The FSM may further include a fuel reservoir positioned upstream of the engine to provide a localized supply of fuel. The reservoir can serve multiple functions, including damping pressure fluctuations, separating vapor from liquid fuel, and maintaining a substantially continuous supply of fuel under varying vessel operating conditions such as acceleration, deceleration, or wave-induced motion.

Effective management of fuel vapor within the reservoir is important to reliable engine performance. Vapor formation can occur due to heat transfer from the engine or surrounding environment, pressure variations within the fuel system, or agitation of the fuel during vessel operation. Excessive vapor within the reservoir can reduce pump efficiency, contribute to cavitation, and cause fluctuations in delivered fuel pressure. In certain operating conditions, accumulated vapor interferes with the delivery of liquid fuel to the engine, potentially resulting in partial or complete vapor lock. Such conditions may lead to hesitation, loss of power, or engine stall. By regulating vapor accumulation and controlling fuel temperature and pressure within the reservoir, the FSM can promote consistent fuel delivery, mitigate the risk of vapor lock, and enhance overall engine reliability and efficiency.

Certain conventional systems manage fuel vapor using a vented configuration in which vapor is discharged from the reservoir to the surrounding environment. Although venting can relieve excess pressure and reduce vapor accumulation within the reservoir, such arrangements may result in loss of fuel mass, reduced system efficiency, and increased evaporative emissions. Other systems employ vapor recovery configurations in which fuel vapor is routed back into the fuel stream, for example by way of a secondary pump that transports a mixture of vapor and liquid fuel for reintroduction into the engine. While recovery-based systems can improve fuel utilization relative to vented arrangements, such systems may introduce additional complexity and may require further optimization to ensure efficient vapor handling, stable fuel pressure control, and adequate fuel delivery in response to varying engine operating conditions and fuel demand.

### SUMMARY

Accordingly, there remains a need for a fuel supply module and associated vapor management system capable of effectively controlling fuel vapor within a reservoir, maintaining stable fuel pressure and temperature, mitigating the risk of vapor lock, and delivering fuel to a marine engine in a manner responsive to varying operating conditions and engine fuel demand, while improving overall system efficiency and reliability.

In brief overview, the present disclosure relates generally to fuel delivery systems and, more particularly, to a fuel supply module configured to deliver liquid fuel from a fuel tank to a fuel rail while managing ullage and returned fuel within a housing.

In one embodiment, a fuel supply module includes a fuel reservoir containing a low-pressure sump pump and a high-pressure main pump. The low-pressure sump pump delivers fuel from a fuel tank into the fuel reservoir. The high-pressure main pump draws fuel from the fuel reservoir and ullage from a vapor reservoir for discharge to a fuel rail. A fuel pump regulator is fluidly connected to an outlet of the high-pressure main pump and returns excess fuel to the fuel reservoir through a regulator return line.

In certain embodiments, the fuel supply module further includes an inlet adapter disposed within a housing that defines a fuel reservoir and a vapor reservoir. The inlet adapter includes an upper cup and a lower cup that cooperates with the housing to define the vapor reservoir and the fuel reservoir. The upper cup includes one or more ports placing the fuel reservoir in communication with the vapor reservoir. The lower cup includes an inlet and a vapor opening, respectively configured to deliver liquid fuel from the fuel reservoir and pull ullage from the vapor reservoir to the high-pressure main pump.

In embodiments, a column extends from the upper cup and defines the vapor opening placing the upper interior in communication with the lower interior. Transfer of ullage from the fuel reservoir through the ports into the vapor reservoir, together with ullage communication through the column, promotes a favorable level of liquid fuel within the housing and supports liquid fuel delivery to the high-pressure main pump.

The disclosed fuel supply module integrates vapor management and returned-fuel cooling within a compact housing. The structural arrangement of the inlet adapter, vapor passage, and heat exchanger promotes stable fuel delivery to the high-pressure main pump while reducing vapor accumulation within the housing.

These and other features and advantages of the disclosed technology will become more apparent from the following detailed description and the appended claims.

### BRIEF DESCRIPTION OF THE DRAWINGS

Various aspects of the present disclosure are discussed herein with reference to the accompanying Figures. It will be appreciated that for simplicity and clarity of illustration, elements shown in the drawings have not necessarily been drawn accurately or to scale. For example, the dimensions of some of the elements can be exaggerated relative to other elements for clarity.

Further, where considered appropriate, reference numerals can be repeated among the drawings to indicate corresponding or analogous elements. For purposes of clarity, however, not every component can be labeled in every drawing. The Figures are provided for the purposes of illustration and explanation and are not intended as a definition of the limits of the disclosure.

FIG. 1 is a schematic diagram of a boat and an associated fuel system, showing fuel flow from a fuel tank to a fuel rail for delivery to an engine in accordance with the subject technology.

FIG. 2 is a flow diagram of a fuel supply module in accordance with the subject technology.

FIG. 3 is a front elevational view of the fuel supply module in accordance with the subject technology.

FIG. 4 is a top view of the fuel supply module in accordance with the subject technology, the view being partially in cross-section to reveal a portion of the inlet adapter of the fuel supply module.

FIG. 5 is a sectional elevational view of the fuel supply module in accordance with the subject technology.

FIG. 6 is an exploded view of the fuel supply module in accordance with the subject technology.

FIG. 7 is a sectional elevational view of a high-pressure fuel pump, the inlet adapter, and a vapor reservoir in accordance with the subject technology.

FIG. 8 is a sectional elevational view of the fuel supply module showing a coolant flow path in accordance with the subject technology.

FIG. 9 is a left-side, sectional elevational view of the fuel supply module in accordance with the subject technology.

FIG. 10 is a right-side, sectional elevational view of the fuel supply module in accordance with the subject technology.

FIG. 11A is a perspective view of an inlet adapter for use in the fuel supply module in accordance with the subject technology.

FIG. 11B is a top view of the inlet adapter for use in the fuel supply module in accordance with the subject technology.

FIG. 11C is a bottom view of the inlet adapter for use in the fuel supply module in accordance with the subject technology.

FIG. 12A is a perspective view of another inlet adapter in isolation in accordance with the subject technology.

FIG. 12B is a top view of the inlet adapter of FIG. 12A in isolation.

FIG. 12C is a bottom view of an inlet adapter of FIGS. 12A and 12B in isolation.

FIG. 13 is a detailed elevational view of the inlet adapter and a vapor reservoir.

### DETAILED DESCRIPTION

The subject technology overcomes many of the prior art problems associated with fuel supply modules. The advantages, and other features of the technology disclosed herein, will become more readily apparent to those having ordinary skill in the art from the following detailed description of certain exemplary embodiments taken in combination with the drawings and wherein like reference numerals identify similar structural elements. It should be noted that directional indications such as vertical, horizontal, upward, downward, right, left, proximal, distal, and the like, are used with respect to the figures and not meant in a limiting manner.

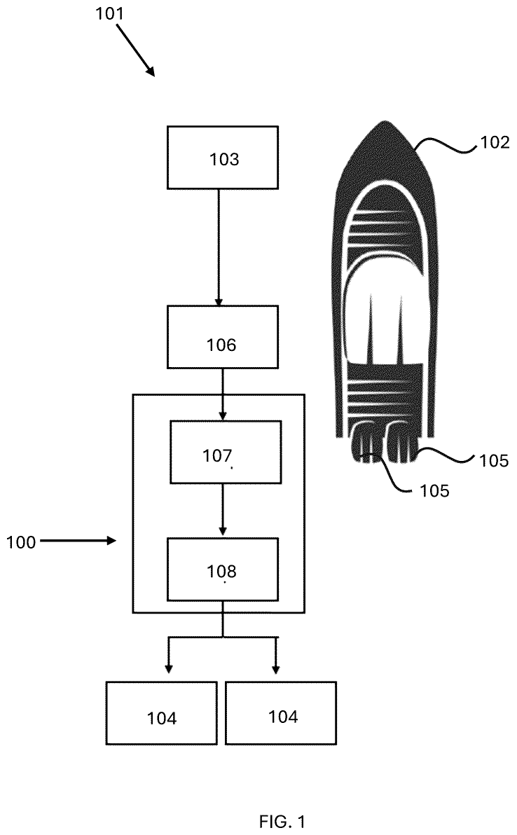

Referring to FIG. 1, a fuel system 101 for a boat 102 is schematically illustrated. The fuel system 101 extends between a remote fuel tank 103 and one or more fuel rails 104 that provide fuel to the motors 105. In certain embodiments, the fuel system 101 may include a transfer pump 106 positioned downstream of the fuel tank 103 to transfer fuel from the fuel tank 103 to a fuel supply module (FSM) 100 located downstream of the transfer pump 106. In other embodiments, the FSM 100 is configured to draw fuel directly from the remote fuel tank 103 without the use of the transfer pump 106. The FSM 100 houses a low-pressure sump pump 107 and a high-pressure main pump 108.

In operation, fuel is conveyed from the fuel tank 103 either by the transfer pump 106, when provided, or by the operation of the sump pump 107 and the main pump 108 within the FSM 100, which are also configured to draw fuel from the remote fuel tank 103. The fuel is drawn into the sump pump 107 and released into a fuel reservoir 109 as a first stage. Then, the fuel is further pressurized by the main pump 108, before entering the fuel rails 104 for consumption by the motors 105.

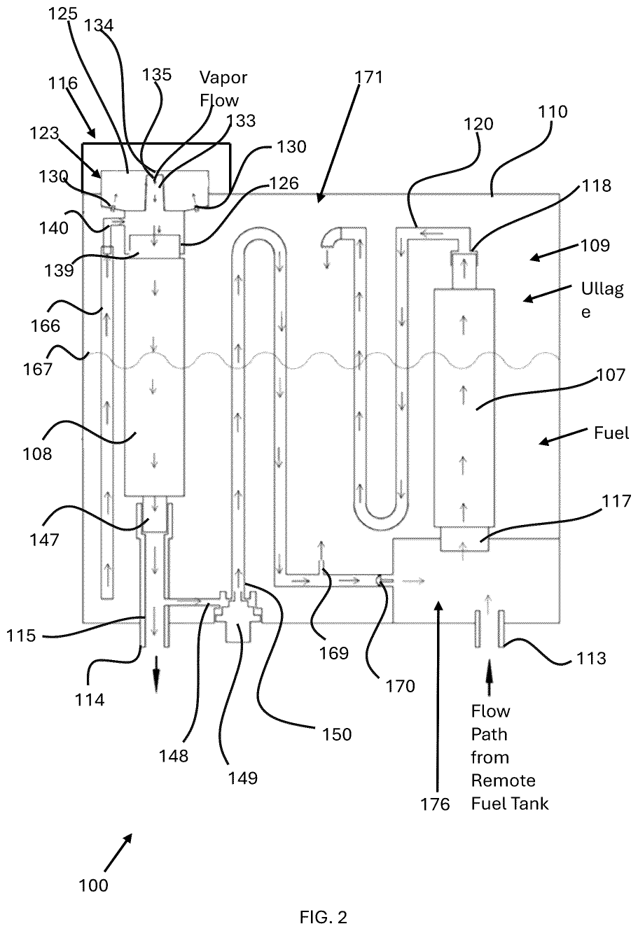

Referring to FIG. 2, in brief overview, an inlet adapter assembly 123 couples to a pump so that the pump may withdraw ullage to be consumed by an engine. Thus, vapor lock is prevented. The inlet adapter assembly 123 forms a vapor reservoir 116 with a passageway for ullage into the vapor reservoir 116 and, in turn, the pump.

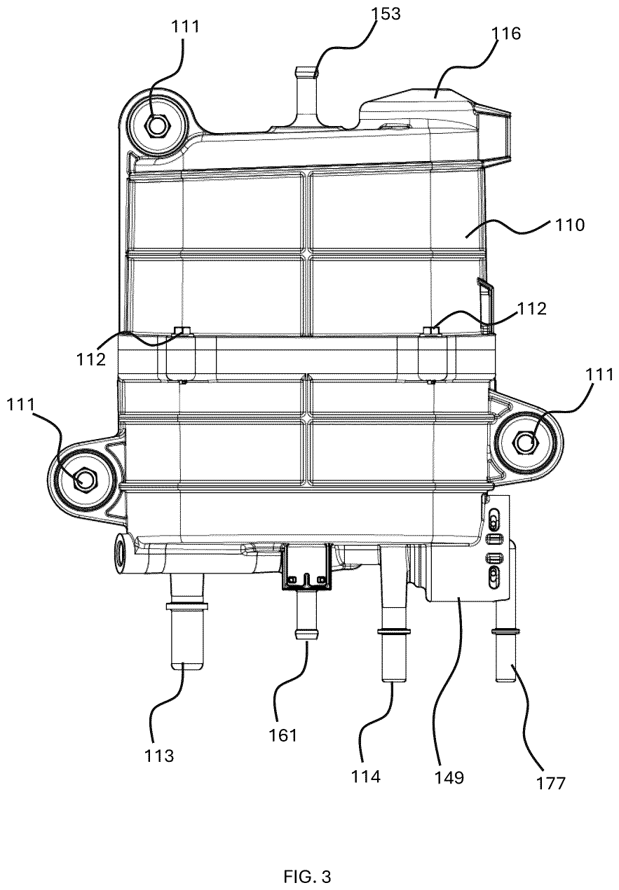

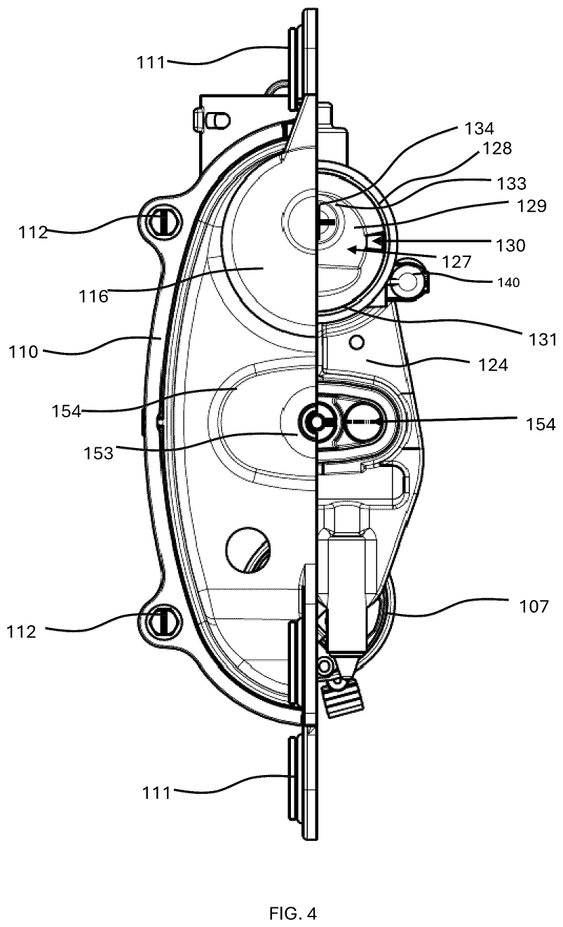

Referring to FIGS. 3-6, the FSM 100 is contained within a housing 110. The housing 110 includes fasteners 111 for securing the FSM 100 within a boat 102. The housing 110 may be comprised of multiple individual pieces, secured together by screws 112 or other securing means (not shown). The housing 110 includes a reservoir inlet 113 for admitting fuel and a fuel rail discharge port 114 for providing fuel to the rails 104. Fuel generally flows from the reservoir inlet 113, through two pumps 107, 108 in series, and to the outlet pathway 115, as described in greater detail below.

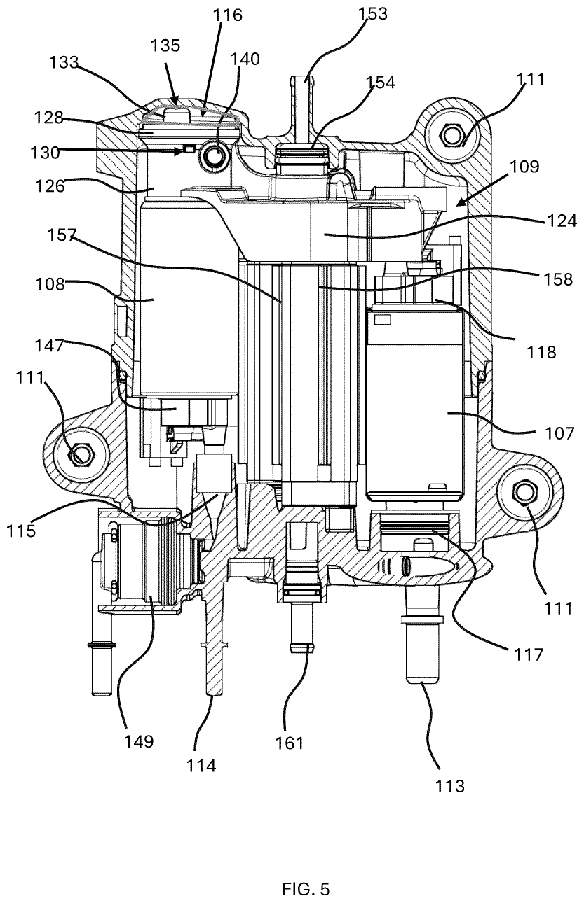

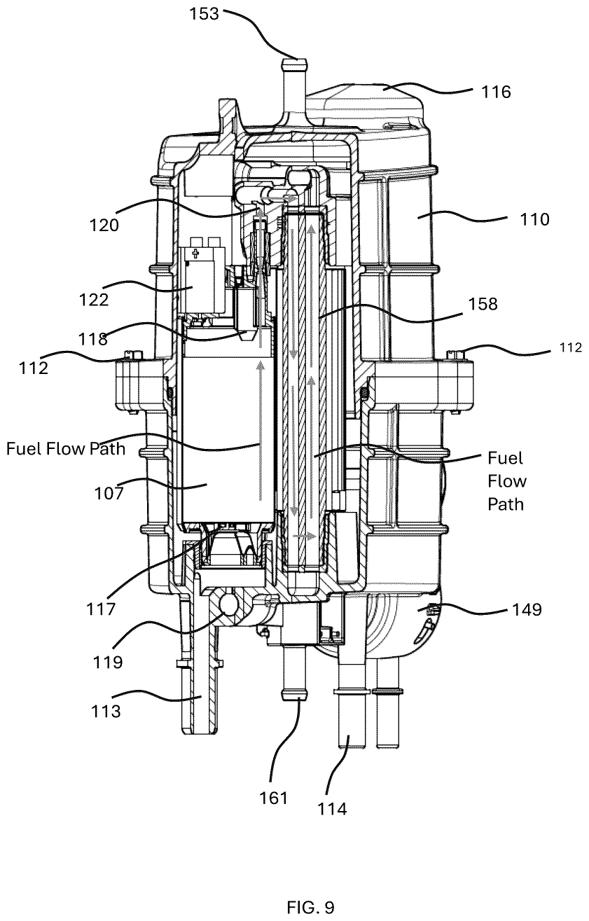

The housing 110 includes a fuel reservoir 109 and a vapor reservoir 116 (See FIGS. 2 and 5). The fuel reservoir 109 is configured to hold fuel and, typically, ullage, while the vapor reservoir 116 is for ullage. The reservoir inlet 113 is coupled to the remote fuel tank 103 and provides an entry point for fuel into the fuel reservoir 109. The sump pump 107 is positioned within the fuel reservoir 109 proximate the reservoir inlet 113 and includes an intake 117 and an outlet 118. The intake 117 is fluidly coupled to the fuel reservoir 109 such that the sump pump 107 draws fuel from the fuel reservoir 109 and into the sump pump 107. In some embodiments, the intake 117 comprises a ball check valve 119 configured to permit flow of fuel toward the sump pump 107 and to inhibit reverse flow toward the fuel reservoir 109 (best seen in FIG. 9).

The outlet 118 of the sump pump 107 is fluidly coupled to a reservoir exit conduit 120 configured to receive fuel from the sump pump 107 and deliver the fuel to the fuel reservoir 109. The reservoir exit conduit 120 directs fuel into the fuel reservoir 109 in a controlled manner to promote circulation within the fuel reservoir 109. For example, the reservoir exit conduit 120 may generate localized jetting and swirl within the fuel reservoir 109, which can assist in separating entrained vapor 121 from liquid fuel. The sump pump 107 may be powered by a battery 122 contained within the housing 110. The sump pump 107 may also include an electric motor (not shown) configured to receive power from an external power source, such as an engine battery or alternator.

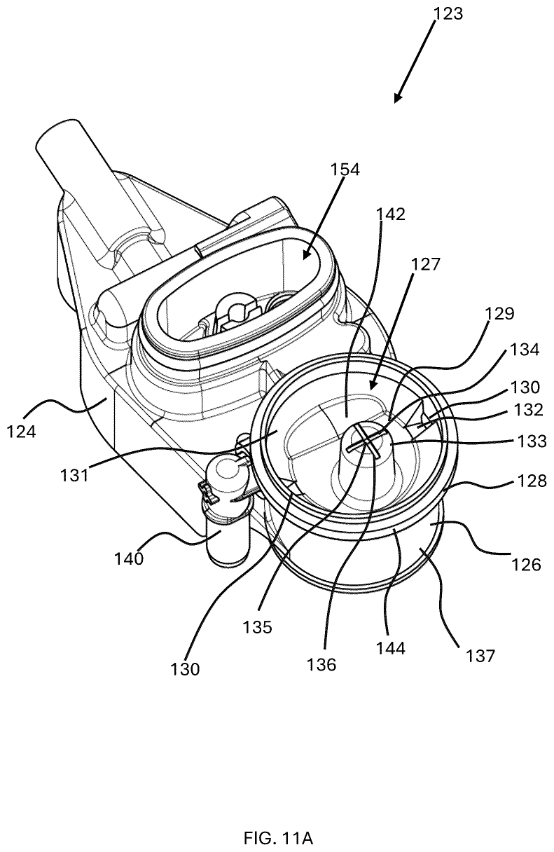

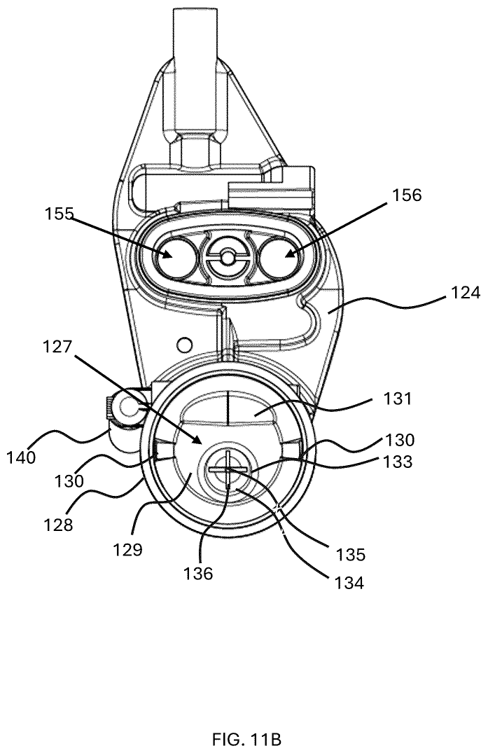

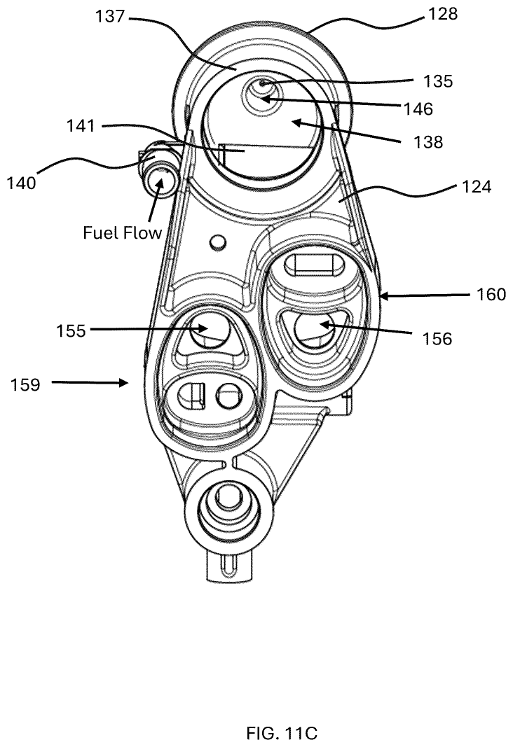

Still referring to FIGS. 3-6, the FSM 100 also includes an inlet adapter 123 downstream of the sump pump 107 for providing fuel and ullage to the high-pressure main pump 108. As best seen in isolation in FIGS. 11A and 11B, the inlet adapter 123 comprises an adapter body 124 which further includes an upper cup 125 and a lower cup 126 extending from the adapter body 124. The inlet adapter 123 couples to the sump pump 107 and the main pump 108 by the lower cup 126, inside of the housing 110 (best seen at FIG. 5).

An upper interior 127 of the upper cup 125 is defined by a cylindrical upper sidewall 128. The upper interior 127 includes a bottom 129 having ports 130 defined therein for fluid communication with the fuel reservoir 109. A sloped sidewall 131 extends around the circumference of the upper interior 127 between the upper sidewall 128 and the bottom 129 to pool fuel in the bottom 129. A ramp 132 drains the pooled fuel, if any, toward the ports 130. A column 133 extends upwardly from the bottom 129 of the upper cup 125, terminating in an apex 134 that extends above the upper sidewall 128. At the apex 134, the column 133 further defines a vapor opening 135 and grooves 136.

As best seen in FIG. 11C, the lower cup 126 has a lower sidewall 137 defining a lower interior 138. The lower interior 138 communicates with an entry 139 of the main pump 108. The lower cup 126 further defines an inlet 140 in fluid communication with the lower interior 138. The inlet 140 receives liquid fuel from the fuel reservoir 109 and directs the fuel to a reception area 141 of the lower interior 138 for delivery to the main pump 108. To create the reception area 141, a raised shelf 142 is evident in the bottom 143 as seen in FIG. 11A.

The upper cup 125 seals against the housing 110. Either of the outer surface 144 of the upper sidewall 128 or the housing 110 may carry an O-ring in an annular groove or the like so that a barrier is formed. Indeed, the barrier separates the vapor reservoir 116 from the fuel reservoir 109. Alternatively, the inlet adapter 123 and/or the housing 110 are formed from resiliently flexible material in a snug fit so that a barrier is formed without an O-ring seal. The inlet adapter 123 may also thread into the housing 110 to form the sealed vapor reservoir 116.

When the inlet adapter 123 is installed, the seal or sealed area of the adapter 123 cooperates with the housing 110 to divide an internal volume of the housing 110 into an upper vapor reservoir 116 and a lower fuel reservoir 109 (best seen at FIG. 2). The upper cup 125 extends primarily into the vapor reservoir 116, while the lower cup 126 extends primarily into the fuel reservoir 109. The ports 130 allow ullage to pass from the lower fuel reservoir 109 into the upper vapor reservoir 116. As best seen in FIG. 5, the upper vapor reservoir 116 is elevated with respect to the rest of the interior of the housing 110.

Still referring to FIG. 11C, the column 133 further defines a column interior 146 in fluid communication with the vapor reservoir 116 through the vapor opening 135. The column interior 146 is in fluid communication with the lower interior 138 to permit ullage to flow downward therethrough. In this manner, vapor from the vapor reservoir 116 is permitted to flow through the column 133, into the lower interior 138, and on into the main pump 108. As such, vapor is combined with the fuel sent out on the rails 104 and consumed by the motors 105.

Referring again to FIGS. 3-6, the main pump 108 includes an entry 139 positioned in fluid communication with the lower interior 138 and an exit 147 coupled to an outlet pathway 115. The outlet pathway 115 directs pressurized fuel from the main pump 108 to the fuel rails 104 via the fuel rail discharge port 114. The main pump 108 may also be powered by the battery 122 contained within the housing 110.

A regulator transfer line 148 fluidly couples a fuel regulator 149 to the outlet pathway 115 at a location proximate the fuel rail discharge port 114. The fuel regulator 149 is configured to divert excess fuel from the outlet pathway 115 through a regulator return line 150 and back to the fuel reservoir 109 in the event that the fuel pressure 151 is too great or if motor 105 demand suddenly decreases.

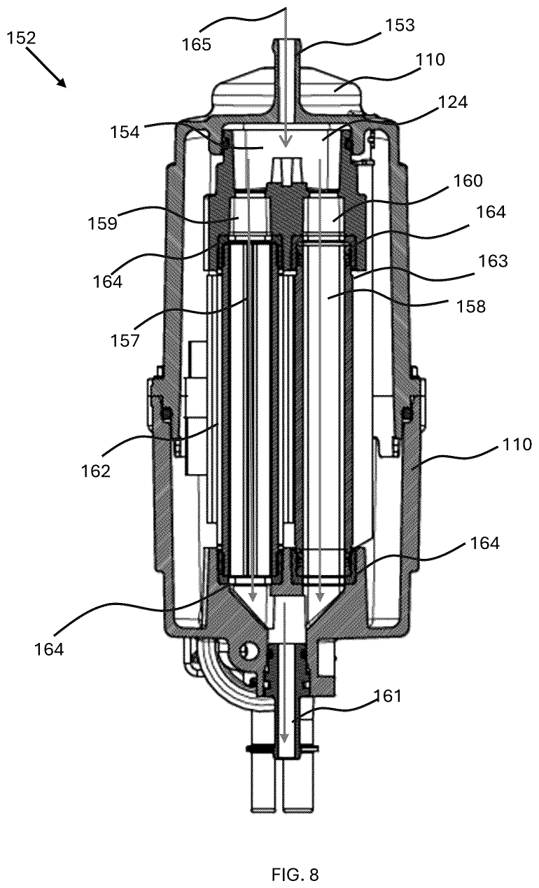

As best seen in FIG. 8, the FSM 100 also includes a dual-pass cooling system 152. The cooling system 152 includes a coolant entry port 153 extending from the housing 110, configured to receive coolant from an external source. The coolant entry port 153 communicates with a coolant chamber 154 located on the inlet adapter 123. The coolant chamber 154 receives coolant and distributes the coolant between two coolant openings 155 and 156. Each coolant opening 155, 156 couples to a respective heat exchanger 157, 158 via a coolant adapter channel 159, 160 to deliver coolant to the heat exchanger 157, 158. The heat exchangers 157, 158 extend through the FSM 100 and terminate in a singular coolant exit port 161.

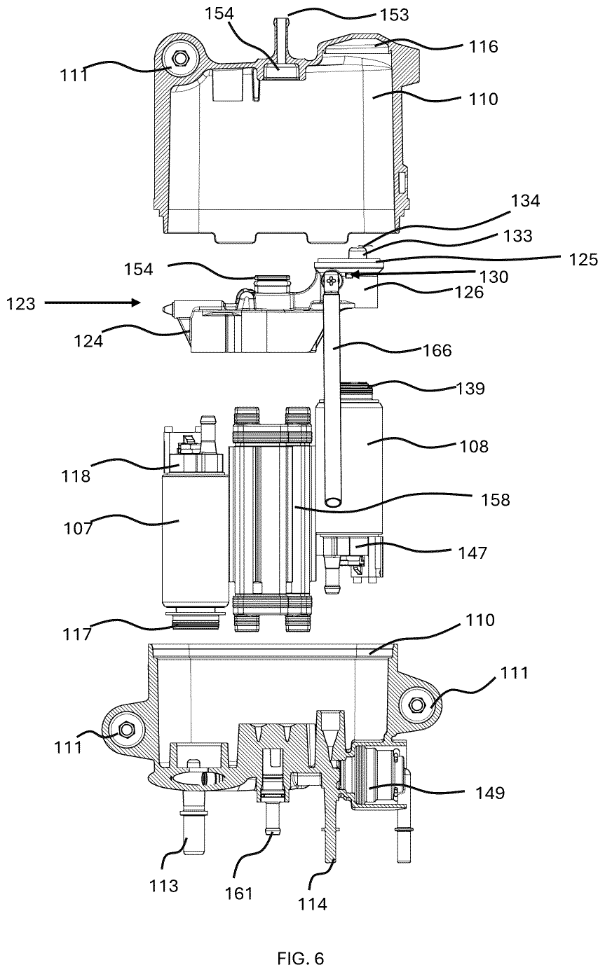

As best seen in FIGS. 5 and 6, the illustrated embodiment includes two heat exchangers 157, 158. The heat exchangers 157, 158 are positioned within the FSM 100 adjacent the regulator return line 150. Each heat exchanger 157, 158 couples to two fuel channels 162, 163. The fuel channels 162, 163 are connected by a redirecting portion 164 such that fuel follows a dual-pass flow path including a first pass extending in a first direction relative to a coolant flow path 165 and a second pass extending in an opposite direction relative to the coolant flow path 165.

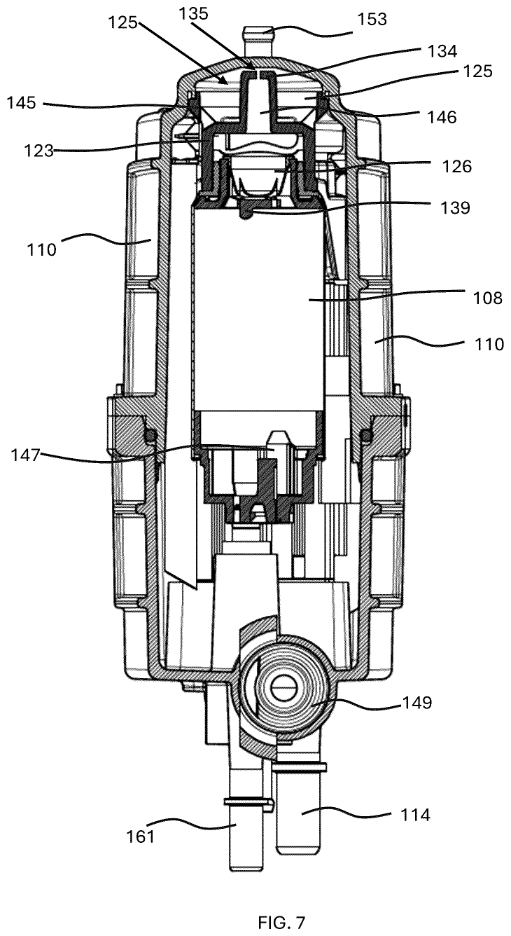

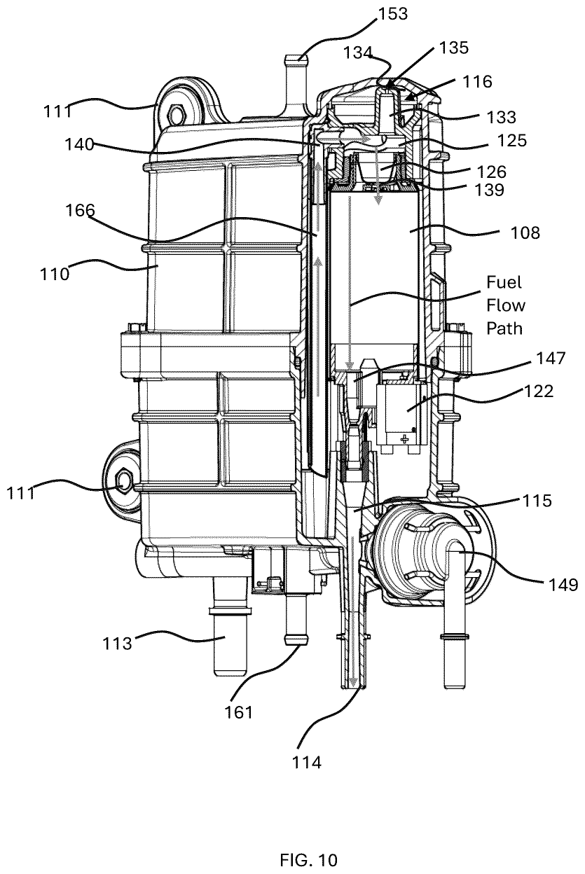

Referring now to FIGS. 1-11C but well suited for review of FIG. 2, in operation, the transfer pump 106 transports fuel from the remote fuel tank 103 through the reservoir inlet 113 and into the fuel reservoir 109. The sump pump 107 draws fuel through the intake 117 and discharges fuel through the outlet 118 to the reservoir exit conduit 120. The main pump 108 then draws fuel for delivery to the fuel rails 104.

The main pump 108 draws fuel from the fuel reservoir 109 through the withdrawal line 166 and into the lower cup 126. The main pump 108 also draws ullage through the column vapor opening 135. A typical fuel level 167 is shown in FIG. 2. By constant withdraw of ullage, the amount of ullage is controlled. The size of the vapor opening 135 and ports 130 determines a rate of ullage withdrawal.

Under increased operating conditions, the main pump 108 generates increased fuel output, temporarily lowering the fuel level in the fuel reservoir 109. The rate of ullage withdrawal will remain unchanged. Eventually, the pumps 107, 108 respond to meet demand, and the fuel level returns to normal.

Under decreased operating conditions, the fuel level may rise and enter the upper interior 127 through the ports 130. Fuel may be pulled through the column 133 and delivered to the rails 104 until the fuel level lowers. Generally, the shape and position of the upper interior 127 is formed to minimize an amount of fuel therein. Further, as ullage enters the housing 110, the housing 110 is also shaped to direct ullage into the upper interior.

Fuel, mixed with ullage, exits the main pump 108 at the main pump exit 147 into the outlet pathway 115 and is fed to the fuel rails 104 via the fuel rail discharge port 114.

A manifold reference port 177 communicates the fuel regulator 149 and an engine intake manifold (not shown). When fuel pressure exceeds a threshold pressure relative to intake manifold pressure, the fuel regulator 149 diverts fuel through the regulator transfer line 148 and regulator return line 150.

Fuel in the regulator return line 150 passes through the fuel channels 162, 163 of the heat exchangers 157, 158 before returning to the fuel reservoir 109. Further, fuel may also pass through a check valve 170 and into a negative pressure zone 176 fluidly separated from the fuel reservoir 109.

The intake 117 of the low-pressure sump pump 107 is positioned within the negative pressure zone 176. During operation, actuation of the sump pump 107 reduces pressure within the negative pressure zone 176 relative to the fuel reservoir 109, thereby drawing fuel from the remote fuel tank 103 toward the FSM 100. The check valve 170 provides fluid communication from the fuel reservoir 109 to the negative pressure zone 176 and is configured to discharge fuel into the negative pressure zone 176, thereby maintaining pressure within the fuel reservoir 109 while establishing a recirculation path through the sump pump 107.

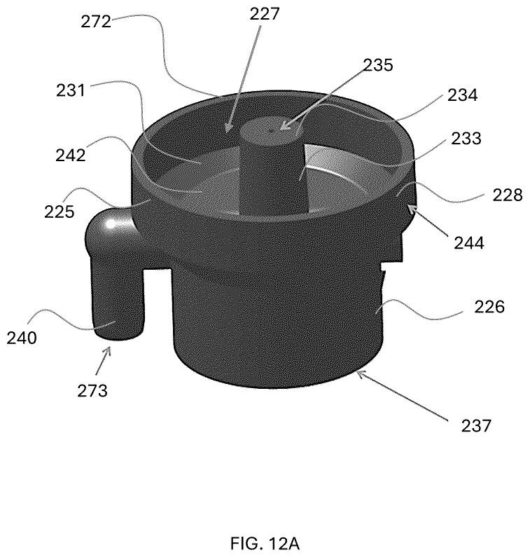

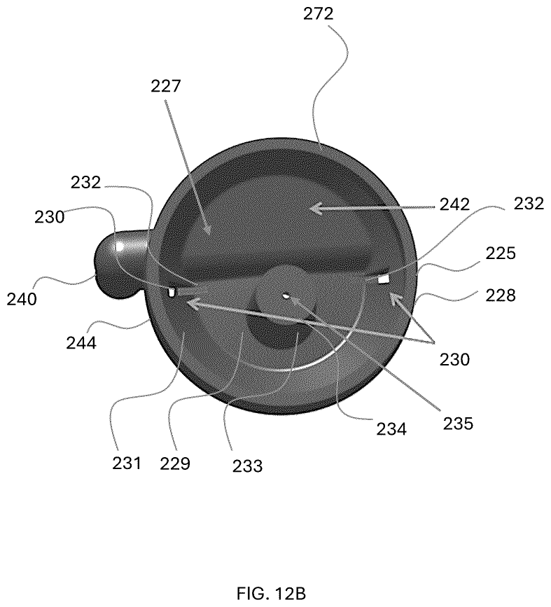

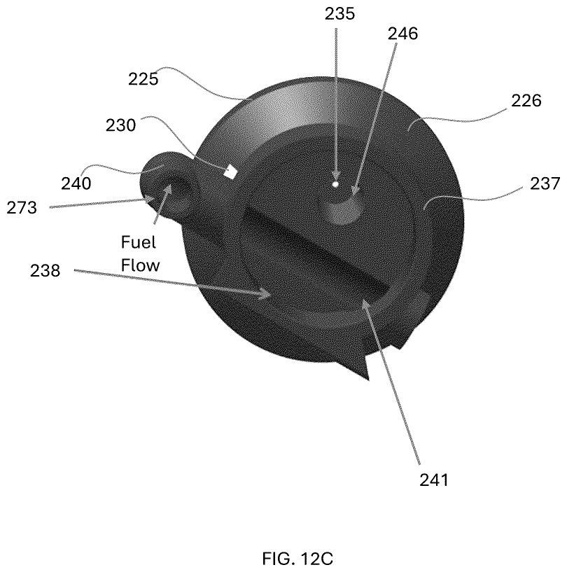

Referring to FIGS. 12A-C, another embodiment of an adapter cup assembly 200 is shown. The inlet adapter assembly 200 includes structural features analogous to inlet adapter 123 and establishes fluid communication between a vapor reservoir and a fuel reservoir to permit ullage to flow to a pump. Similar elements to those described in connection with above-described embodiments are indicated with the like reference numbers but in the 200 series.

Many elements are functionally the same as those of the foregoing embodiments and, thus, are not further described herein. The primary difference between the adapter cup assembly 200 and the assembly 100 is that the adapter cup assembly 200 is a stand alone item that may be fitted to a pump, even a pump originally not fitted with such.

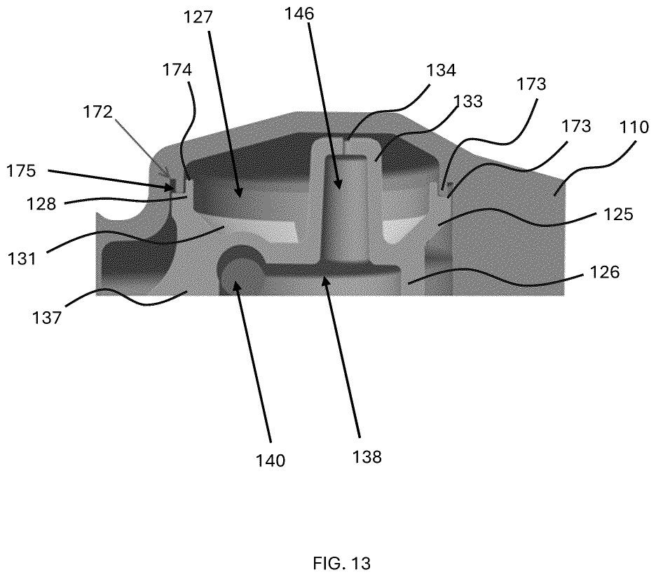

Referring to FIG. 13 the housing 110 and the upper cup 125 may also cooperate to define a tortuous path 172 between the fuel reservoir 109 and the vapor reservoir 116. A vertical flange 173 formed on the housing 110 extends downwardly toward a stop surface 173 of the upper cup 125. The vertical flange 173 and the housing 110 form a cavity 172 therebetween. A retention lip 174 on the upper cup 125 extends upwardly, adjacent to and substantially parallel with the vertical flange 173. The vertical flange 173, the retention lip 174, and the cavity 175 restrict direct liquid fuel transfer between the fuel reservoir 109 and the vapor reservoir 116 while permitting vapor movement therebetween.

It will be appreciated by those of ordinary skill in the pertinent art that various changes and/or modifications may be made without departing from the spirit or scope of the invention as defined by the appended claims.

What is claimed is:

1. A fuel supply module for delivering liquid fuel from a fuel tank to a fuel rail, the fuel supply module comprising:
a) a housing forming a fuel reservoir in fluid communication with the fuel tank and a vapor reservoir above the fuel reservoir;
b) a sump pump in the housing having an inlet fluidly connected to the fuel tank and an outlet fluidly connected to the fuel reservoir;
c) a main pump in the housing having an opening fluidly connected to the fuel reservoir and an exit fluidly connected to the fuel rail; and
d) an inlet adapter coupled to the main pump, the inlet adapter having:
i) an upper cup having a cylindrical upper sidewall forming an upper interior, the upper cup having a bottom defining a port;
ii) a lower cup depending from the upper cup and defining a lower interior and an inlet for drawing liquid fuel from the fuel reservoir into the lower interior for delivery to the main pump; and
iii) a column extending upwardly from the bottom of the upper cup and defining a column vapor opening for fluid communication between the vapor reservoir and the lower interior; and
wherein: an outer surface of the cylindrical upper sidewall and housing cooperate to divide the fuel reservoir and the vapor reservoir; the sump pump delivers fuel from the fuel tank to the fuel reservoir; the main pump draws fuel from the fuel reservoir and discharges the fuel to the fuel rail; and the port permit ullage to flow from the fuel reservoir into the upper interior, such that as fuel is pumped to the fuel rail by the main pump, ullage is drawn into the fuel.

2. The fuel supply module of claim 1, wherein the upper cup extends into the vapor reservoir, and the lower cup extends into the fuel reservoir.

3. The fuel supply module of claim 1, further comprising a fuel pump regulator having a regulator transfer line fluidly connected to the main pump exit and a regulator return line is fluidly connected to the fuel reservoir.

4. The fuel supply module of claim 3, wherein excess fuel from the exit is routed through the fuel pump regulator and returned to the fuel reservoir.

5. The fuel supply module of claim 3, further comprising a heat exchanger configured to receive fuel returned via the regulator return line prior to reintroduction into the fuel reservoir.

6. The fuel supply module of claim 1, wherein the upper interior is funnel-shaped with a down ramp ending in the port.

7. The fuel supply module of claim 6, wherein the fuel pump regulator discharges fuel into the fuel reservoir at a location configured to promote fuel re-uptake by the sump pump.

8. An inlet adapter for a pump in a housing defining a vapor reservoir and a fuel reservoir, the inlet adapter comprising:
an upper cup having:
a bottom defining a port in fluid communication with the vapor reservoir;
an upper sidewall upstanding from the bottom to form an upper interior filled via the port; and
a hollow column extending upwardly from the bottom of the upper cup, the hollow column defining a column vapor opening; and
a lower cup having:
a lower sidewall having a lower sidewall depending from the bottom and defining a lower interior; and
a coupling extending from the lower sidewall and configured to connect to a withdrawal line, the coupling defining an inlet for drawing liquid fuel via the withdrawal line from the fuel reservoir into the lower interior for delivery to the pump,
wherein the column vapor opening is located at an apex of the inlet adapter and establishes fluid communication between the upper interior and the lower interior to permit ullage to flow from the vapor reservoir through the column vapor opening and into the pump for consumption by an engine.

9. The inlet adapter of claim 8, wherein the bottom is sloped and the port is near a low point so that fuel in the upper interior will flow into the vapor reservoir and, in turn, to the fuel reservoir.

10. The inlet adapter of claim 8, further comprising a seal on an outer surface of the upper sidewall which cooperates with the housing to separate the vapor reservoir from the fuel reservoir.

11. The inlet adapter of claim 8, wherein the upper cup is positioned substantially within the vapor reservoir and the lower cup is positioned substantially within the fuel reservoir.

12. The inlet adapter of claim 8, wherein the column includes one or more grooves defined in an upper end thereof to facilitate ullage transfer into the column vapor opening.

13. The inlet adapter of claim 8, wherein withdrawal of liquid fuel from the lower interior reduces pressure within the lower interior to promote transfer of ullage from the vapor reservoir through the column vapor opening.

14. The inlet adapter of claim 8, wherein flow of fuel to the engine lowers fuel in the fuel reservoir and allows fuel to be drained from the upper interior, through the port and back to the fuel reservoir.

15. A fuel supply module configured to manage vapor within a fuel system, comprising:
a housing;
a seal dividing an interior of the housing into a fuel reservoir and a vapor reservoir positioned above the fuel reservoir;
a main pump having an inlet in fluid communication with the fuel reservoir; and
an inlet adapter disposed within the housing and including:
an upper cup extending into the vapor reservoir and having at least one port placing the fuel reservoir in communication with the vapor reservoir;
a lower cup defining a lower interior fluidly connected to the inlet of the main pump; and
a hollow column extending from the upper cup and defining a vapor opening in communication with the lower interior,
wherein operation of the main pump draws ullage from the vapor reservoir through the hollow column and into the lower interior for delivery toward the main pump.
